(19) United States
(12) Patent Application Publication
(10) Pub. No.: US 2006/0068754 A1
(43) Pub. Date: Mar. 30, 2006

(54) System and method for securing a large infrastructure

(76) Inventors: Helena Goldfarb, Niskayuna, NY (US); Steven Hector Azzaro, Schenectady, NY (US); Thomas Shaginaw, Burnt Hills, NY (US)

Correspondence Address: Patrick S. Yoder;FLETCHER YODER, P.O. Box 692289, Houston, TX, 77269-2289, US

(21) Appl. No.: 10/955,870

(22) Filed: Sep. 30, 2004

(51) Int. Cl. H04Q 7/20

(52) U.S. Cl. 455/410

(57) ABSTRACT

A security monitoring system 10 for a large infrastructure 12 is provided. The system includes several magnetometers 14 disposed around an area 16 of the infrastructure. According to aspects of present technique at least one magnetometer 28 is configured to relay an alert signal indicating a change in a magnetic flux profile around the area. A central unit 56 is configured to receive the alert signal from at least one magnetometer and initiate a response to the alert signal.

### BACKGROUND

The invention relates generally to methods and systems for securing large infrastructures and more particularly to methods and systems for securing pipelines and similar infrastructures.

In recent years, considerable efforts have been made for securing pipelines and associated oil and gas infrastructures, with support from both industry and government. However, the growing level of attacks against and accidents involving pipelines and other infrastructures has not only continued but has resulted in even more serious reductions in productivity, downtime and associated losses. Large infrastructures that may be subject to such risk may include pipelines, rail lines, waterways, electrical distribution networks, water distribution networks, and so forth.

Pipelines and other infrastructures also face unintentional threats, for example from farmers ploughing the fields, from backhoes and other machinery used in construction or excavation activities. Oil and gas infrastructure is not only integral to energy supply but also has vital links to other critical infrastructure like power plants, airports, and military bases. Providing protection for such large infrastructure is a very complicated task due to the vulnerability to sabotage of the easily accessible infrastructure, which usually is widespread and may run alternately in remote and densely populated areas.

Traditionally, the solution to threat against such large infrastructures has been mostly reactive, mainly because of the enormous amount of resources required to safeguard these sites. Ground and aerial patrols have been used, but these have limitations of timely preparedness for withstanding and responding to a threat effectively, and are not very reliable and feasible for round the clock security. Some recent developments in pipeline security systems include use of acoustic monitoring, geophones, fiber optic cables and satellite surveillance. These have several limitations. For example, acoustic monitoring has a limited ability to prevent damage. Geophones and fiber optic cables need to be physically dug-in right of way (ROW), thus increasing pipeline vulnerability and also associated high costs. Satellite surveillance is expensive and is not feasible as a sole method for real time threat detection.

Therefore, there is a need for an improved system and method for detecting threats for large infrastructures like the pipelines and other infrastructures, that proactively delivers threat warnings and prevents or reduces the risk of potential damage.

### BRIEF DESCRIPTION

According to one aspect of the present technique, a security monitoring system for a large infrastructure is provided. The system includes multiple magnetometers disposed around an area of the infrastructure. At least one magnetometer is configured to relay an alert signal indicating a change in a magnetic flux profile around the area. A central unit is configured to receive the alert signal and to initiate a response to the alert signal.

Another aspect of the present technique is a method for securing a large infrastructure. The method includes establishing a wireless network around the large infrastructure using multiple magnetometers. A magnetic flux and a change in magnetic flux profile are sensed by the magnetometers around the large infrastructure and a sensed signal is generated. The sensed signal is analyzed to determine whether there is a local disturbance around the large infrastructure. The change in the magnetic flux may indicate the presence of metal objects, indicating the local disturbance.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of a security monitoring system for a large pipeline infrastructure according to aspects of the present technique;

FIG. 2 is a diagrammatic representation of one area of the large infrastructure of FIG. 1, with a network of magnetometers according to aspects of the present technique; and

FIG. 3 is a flowchart illustrating exemplary method steps for securing a large pipeline infrastructure according to aspects of the present technique.

### DETAILED DESCRIPTION

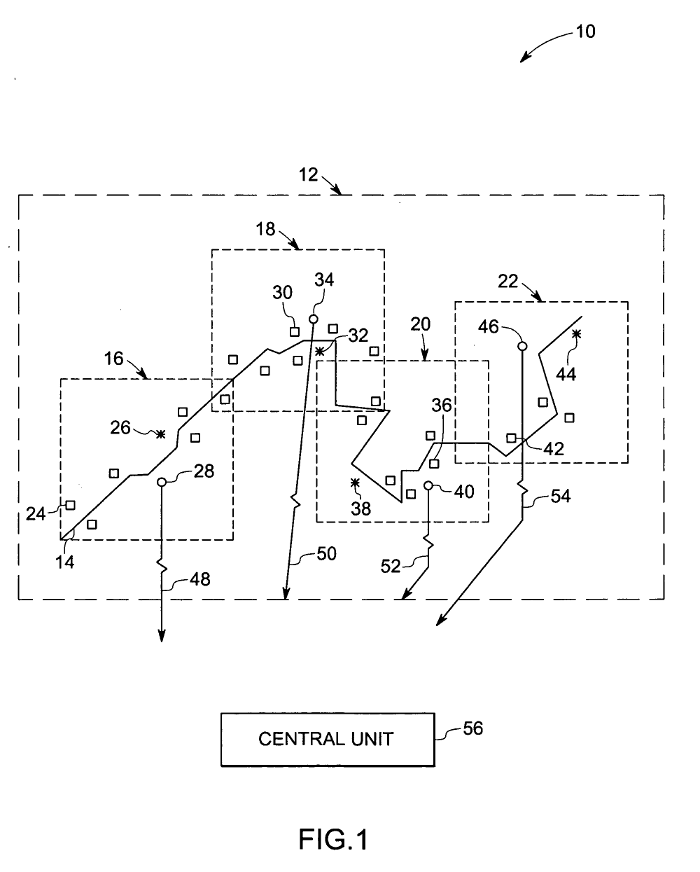

Turning now to drawings, FIG. 1 illustrates a security monitoring system 10 for a large infrastructure, generally denoted by reference numeral 12 that includes a major asset, for example a pipeline 14, which runs across several miles. The region around the pipeline 14 that needs protection can be divided into distinct areas, as illustrated by reference numerals 16, 18, 20 and 22. The choice of these areas is discretionary and may depend on the choice of communication network, or the actual geography of the landscape where the asset to be protected is located. The choice may also depend on sensitivity of a particular area to threat. According to aspects of the present technique, sensing devices may be dispersed around these areas to detect a threat activity, even prior to actual threat or damage to the asset.

In one example, magnetometers, denoted generally by reference numerals, 24-46 are used as sensing devices and are disposed around these areas 16-22. As will be appreciated by those skilled in the art, the magnetometers are sensors that measure earth's magnetic field. Most moving metal objects (i.e. those that contain some magnetic material), as would be appreciated by those skilled in the art, disturb the earth's magnetic field and the presence of this disturbance is detected by these magnetometers. In case of threat to any large infrastructure and more specifically to pipelines, the threat will generally involve the use of a moving metal object, for example, a backhoe, a gun, a hammer or any other similar object, which can be easily detected by the magnetometers.

Multiple magnetometers may be advantageously used in order to distinguish natural or normal disturbances from local disturbances. It would be appreciated by those skilled in the art that any natural disturbance will typically be detected by almost all the magnetometers in a particular area. Any local disturbance will be detected only by one or a group of magnetometers around that area.

In accordance with the present technique, any suitable magnetometers may be employed. However, in a presently contemplated embodiment, micro-electro-mechanical system (MEMS) magnetometers, may be employed as they are low maintenance and inexpensive. Such devices are typically manufactured using batch fabrication techniques, are sturdy and can be dispersed, for example, from an airplane. Thus, deployment and installation for these sensors is simple and does not involve wiring or digging. Further, such magnetometers are small and consume very little energy for integrated circuitry and wireless networking. It should be noted, however, that while magnetometers are described herein as exemplary sensors according to aspects of this technique, any other sensors with similar features as described herein would equally be applicable.

As described herein the magnetometers 24-46 sense at least a magnet flux and a change in magnetic flux including a change in profile of the magnetic flux over time. It should be noted that the terms ‘change in magnetic flux’ and ‘change in magnetic flux profile’ are understood to be used interchangeably in the following description. The change in the magnetic flux or magnetic flux profile occurs due to the presence of metal objects indicating a local disturbance in the magnetic flux. The multiple magnetometers are configured to compensate for any initial metal presence. Such initial flux levels and variations may result from, for example, natural deviations in the earth's magnetic field, the infrastructure itself (e.g. a pipeline or supporting structures), or a construction activity already underway near the infrastructure. Initial levels may also result from appropriate precautions that may already have been deployed, or metal presence due to any natural occurrences like storms, which may have brought some metal objects closer to the infrastructure. The magnetometers, as described above, sense and determine whether the local disturbance is normal (e.g. within an anticipated range of flux levels or changes in flux levels) or not. If any magnetometer senses and determines that the local disturbance is not normal, an alert is relayed to the central unit, which may be a remote monitoring unit in accordance with an exemplary embodiment. The magnetometers or any similar sensors deployed, are thus configured to collect, process and communicate critical information in a reliable and robust fashion.

In an exemplary embodiment, at least one magnetometer may be configured to relay an alert signal indicating a change in a magnetic flux profile around the area. It will be appreciated by those skilled in the art, that the alert signal is relayed in real-time and thus facilitates preventive action to avoid any potential damage. In the illustrated example, magnetometers 28, 34, 40 and 46, for example, are configured to relay alert signals, shown generally by reference numerals 48, 50, 52 and 54 respectively, if there is any change in the magnetic profile around their respective areas 16, 18, 20 and 22. It may be noted that more than one magnetometer may be used for this function depending on the network configuration. A central unit 56 is configured to receive the alert signal from the magnetometers (28, 34, 40 or 46) and to initiate a response to the alert signal to prevent and contain the threat. The response may be a pre-determined action for example an email to the local security agency responsible for area, may be a physical alarm that initiates a set of security protocols, or any other action as determined by the infrastructure operators.

In a specific embodiment, a sensor package may advantageously be used to detect other parameters along with the magnetic flux to gather more information about the local disturbance. For example, the sensor package may include one or more of acoustic sensors, accelerometers, sounders, motion sensors, or exhaust sensors. Such sensor packages may use the additional information, with combinatorial logic, to determine one or more attributes about the area that may indicate a local disturbance.

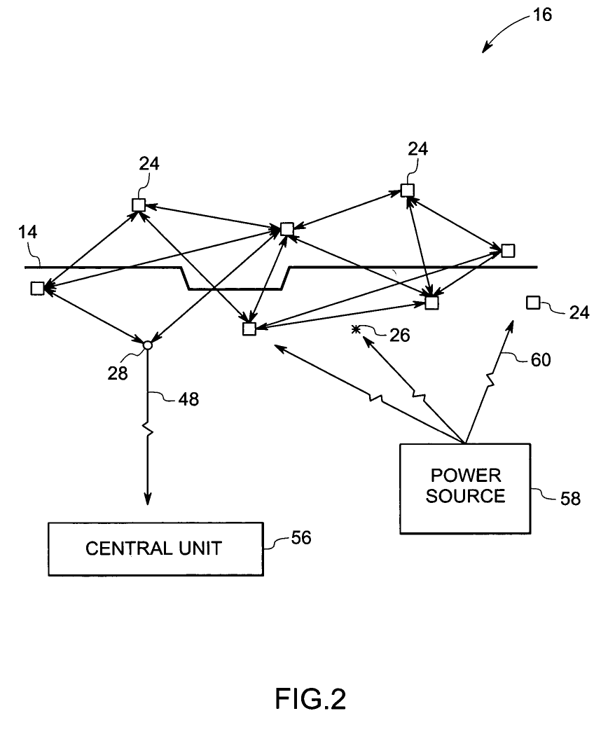

FIG. 2 illustrates, by way of example, the functioning of the sensor network in the area 16, of the infrastructure 12 of FIG. 1. As illustrated, the magnetometers 24-26 may be dispersed around the pipeline 14. The magnetometers establish a network for wirelessly communicating amongst themselves and for relaying the alert signal when a local disturbance that is not normal is detected by any one of the magnetometers. The magnetometers may have a neighbor or a parent-child relationship with each other. Alternately, one magnetometer may be initialized for a unique address and for a known location, for example magnetometer 26 may know its absolute position in terms of latitude and longitude, and it may serve as a “known location sensor”. The other magnetometers 24, 28 may simply relay messages to the magnetometer 26. Different techniques may then be employed to find the location of disturbance. For example, a sounder may used to locate the relative positions of the magnetometers with respect to each other and the point of reference magnetometer (known location sensor). Once the relative positions of the magnetometers are known, the position of any specific magnetometer, for example the magnetometer relaying the alert signal can easily be calculated, when required. Alternatively, a strength of an RF field via a RF receiver may be used to locate the magnetometer relaying the alert signal. In another example, a global positioning system receiver may be used to determine a location of the magnetometer relaying the alert signal. In one or more of above techniques, triangulation may also be used to determine the location of the magnetometer relaying the alert signal. Triangulation may be used in determining absolute position of a magnetometer if there is a point of reference and relative position of the magnetometer to the point of reference is known.

In yet another example, the magnetometers may communicate in a node to node or a hub to hub manner. A dedicated node, for example magnetometer 28, may then be used to relay the alert signal 48 to the central unit 56. This would provide savings in terms of transmission energy. It will be appreciated by those skilled in the art that the network is possible even when the magnetometers have no unique address but may have a fixed frame of reference. The above techniques will be equally applicable to determine the location of the magnetometer relaying the alert, and thus finding the location of disturbance.

Powering the magnetometers is another aspect of the present technique. Because the power requirements are considerably low, the magnetometers may be charged as shown generally by reference numeral 60, by a power source 58, which may be a battery. In one example a solar cell and battery system may be used. In one configuration, the magnetometers may have an integrated battery associated with the internal circuitry of the magnetometers. The magnetometers may also be charged by a power scavenging unit. For example, if the area to be protected is located along roadside or a rail track, vibration from the passing vehicles may be converted into power in a manner generally known to those skilled in the art, and may be used to power the magnetometers. Alternately, the movement of a fluid, such as a fluid in a pipeline may be used to scavenge power. Other alternate energy sources like wind may also be used, depending on the geography of the area being secured.

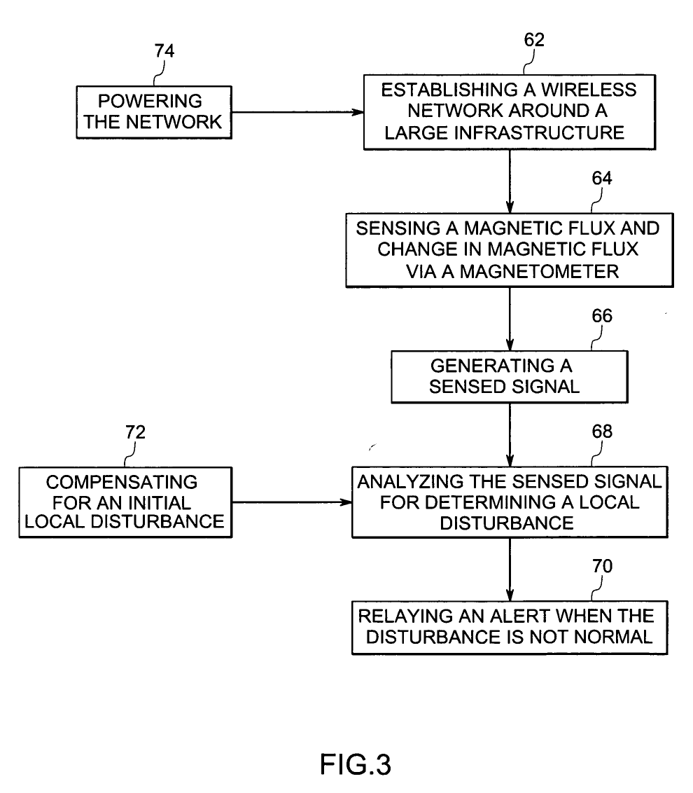

FIG. 3 is a flowchart illustrating exemplary steps for securing a large infrastructure as disclosed. The method includes, at step 62, establishing a network around the large infrastructure using multiple magnetometers or similar sensing devices. The network is advantageously wireless. This process may also include a number of sub-processes, such as for establishment and verification of communications between the sensors, localization of the sensors, implementation of desired communications protocols, and so forth. At step 64, an attribute about the area is sensed, for example, a magnetic flux and a change in magnetic flux profile around the large infrastructure via a magnetometer. A sensed signal is generated at step 66. The sensed signal may be analyzed at step 68 for determining a local disturbance around the large infrastructure. As noted above, the sensing of the signals via the sensors may be performed following calibration of the sensors, such as for base levels of flux at the particular location of the individual sensors.

As noted above, the detection of potential threats to the infrastructure may include, for example, determining whether the local disturbance is normal or not normal. Logic for such analysis may be provided in the individual sensors, or may be performed by particular, dedicated sensors, or by processors either in the field or at a remote location. In case the analysis shows that the local disturbance is not normal, at step 70 an alert is relayed to a central unit or other desired oversight location, as described herein above with reference to FIG. 2.

Other aspects of the present technique, may include a step 72 for compensating for an initial local disturbance or initial metal presence or any other initial attribute so that a false message is not relayed under such conditions. Such compensation may be part of an initialization or commissioning procedure, and may include the calibration described above. Aspects of the present technique may also include a step 74 for powering the network using alternate energy sources as described in reference to FIG. 2.

Aspects of the present technique as described herein thus yield accurate sensing and reliable alerting for providing proactive reliability and safety monitoring for any large infrastructure. Thus false alarms are reduced or prevented which can involve enormous resources. The technique advantageously provides early detection of any threat activity before damage to the asset occurs, and provides time for suitable preventive actions and response. Aspects of the present technique also provide a unique system for monitoring damage and providing real-time alerts using sensing and processing units and a remote alerting system. The technique may further be utilized for recording of events, trend analysis, and data for future prediction tools. It would be well appreciated by those skilled in the art that though the description above relates to protection of a pipeline as an exemplary infrastructure, aspects of present technique are equally applicable to other large infrastructures, such as power stations, railways, airports and other infrastructures which are generally widespread and difficult to physically monitor and secure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A security monitoring system for large infrastructure, comprising:
a plurality of magnetometers disposed around an area of the infrastructure, wherein at least one magnetometer is configured to relay an alert signal indicating a change in a magnetic flux profile in the area.

2. The system of claim 1, further comprising:
a central unit configured to receive the alert signal from the at least one magnetometer and initiate a response to the alert signal.

3. The system of claim 1, wherein the plurality of magnetometers sense at least a magnet flux and the change in magnetic flux profile.

4. The system of claim 1, wherein the change in the magnetic flux profile occurs due to the presence of metal objects indicating a local disturbance in the magnetic flux.

5. The system of claim 4, wherein the plurality of magnetometers compensate for an initial local disturbance.

6. The system of claim 4, wherein the plurality of magnetometers sense and determine whether the local disturbance is normal.

7. The system of claim 4, wherein the at least one magnetometer senses and determines whether the local disturbance is not normal and relays the alert signal to a central unit.

8. The system of claim 1, further comprising a sensor package, the sensor package comprising at least one of an acoustic, an accelerometer, or a sounder and wherein the sensor package determines at least one attribute about the area, the attribute indicating a local disturbance.

9. The system of claim 1, wherein the plurality of magnetometers establish a network for wirelessly communicating the alert signal.

10. The system of claim 9, wherein the magnetometers have a neighbor or a parent child relationship with each other.

11. The system of claim 9, wherein the at least one magnetometer is initialized for a known location.

12. The system of claim 11, wherein the plurality of magnetometers have no known location.

13. The system of claim 12, wherein the magnetometers have at least one fixed frame of reference.

14. The system of claim 12, further comprising a sounder for locating relative positions of the plurality of magnetometers.

15. The system of claim 12, further comprising an RF receiver for locating the at least one magnetometer relaying the alert signal via a strength of RF signal.

16. The system of claim 12, further comprising a global positioning system receiver for determining a location of the at least one magnetometer relaying the alert signal.

17. The system of claim 12, wherein the magnetometers are configured to use triangulation to determine a location of the at least one magnetometer relaying the alert signal.

18. The system of claim 9, wherein the plurality of magnetometers communicate in a node to node or a hub to hub manner.

19. The system of claim 9, wherein a dedicated node is used to relay the alert signal to the central unit.

20. The system of claim 1, wherein the plurality of magnetometers are charged by a battery.

21. The system of claim 20, wherein the battery is a solar cell and battery system.

22. The system of claim 1, wherein the plurality of magnetometers are charged by a power scavenging unit.

23. A security monitoring system for securing a large infrastructure, comprising:
a plurality of magnetometers disposed around the infrastructure and configured to sense magnetic flux and to relay an alert signal indicating a change in magnetic flux around the infrastructure, the plurality of magnetometers establishing a wireless network for communication of the alert signal; and
a remote monitoring unit configured to receive the alert signal from at least one magnetometer and to initiate a response to the alert signal.

24. The system of claim 23, wherein the plurality of magnetometers sense at least a magnet flux and the change in magnetic flux to determine a local disturbance.

25. The system of claim 24, wherein at least one magnetometer senses and determines whether the local disturbance is not normal and relays the alert signal to the remote monitoring unit.

26. The system of claim 23, further comprising a sensor package disposed around the pipeline, the sensor package comprising at least one of an acoustic, an accelerometer, or a sounder, and wherein the sensor package determines at least one attribute about the infrastructure, the attribute indicating a local disturbance.

27. The system of claim 23, wherein the plurality of magnetometers are calibrated for base levels of the magnetic flux at a respective locations of individual magnetometers from the plurality of magnetometers.

28. The system of claim 23, wherein the plurality of magnetometers are charged by a battery.

29. The system of claim 28, wherein the battery is a solar cell and battery system.

30. The system of claim 23, wherein the plurality of magnetometers are charged by a power scavenging unit.

31. A method for securing a large infrastructure, the method comprising:
deploying a plurality of magnetometers around the large infrastructure, the magnetometers forming a wireless network;
sensing at least a magnetic flux and a change in magnetic flux around the large infrastructure via at least one magnetometer and generating a sensed signal; and
analyzing the sensed signal for determining a local disturbance around the large infrastructure,
wherein the change in the magnetic flux occurs due to the presence of metal objects indicating the local disturbance.

32. The method of claim 31, further comprising determining whether the local disturbance is normal or not normal.

33. The method of claim 32, further comprising relaying an alert signal to a central unit when the local disturbance is not normal.

34. The method of claim 33, wherein a dedicated node is used to relay the alert signal to the central unit.

35. The system of claim 31, further comprising compensating for an initial local disturbance.

36. The method of claim 31, wherein the establishing the network comprises establishing a neighbor or a parent child relationship amongst the plurality of magnetometers.

37. The method of claim 31, wherein the at least one magnetometer is initialized for a known location.

38. The method of claim 31, wherein the plurality of magnetometers have no known location.

39. The method of claim 38, wherein the magnetometers have at least one fixed frame of reference.

40. The method of claim 38, further comprising using a sounder for locating relative positions of the plurality of magnetometer.

41. The method of claim 38, further comprising using an RF detector for locating the at least one magnetometer relaying the alert signal.

42. The method of claim 38, further comprising using a global positioning system receiver for determining a location of the at least one magnetometer relaying the alert signal.

43. The method of claim 38, further comprising using triangulation to determine a location of the at least one magnetometer relaying the alert signal.

44. The method of claim 31, wherein the plurality of magnetometers communicate in a node to node or a hub to hub manner.

45. The method of claim 31, further comprising charging the plurality of magnetometers via a battery.

46. The method of claim 45, wherein the battery is a solar cell and battery system.

47. The method of claim 31 further comprising charging the plurality of magnetometers via a power scavenging unit.

48. A method for securing a large infrastructure, the method comprising:
deploying a plurality of magnetometers around the large infrastructure;
sensing at least a magnetic flux and a change in magnetic flux around the large infrastructure via at least one magnetometer and generating a sensed signal; and
analyzing the sensed signal for determining a local disturbance around the large infrastructure,
wherein the change in the magnetic flux occurs due to the presence of metal objects indicating the local disturbance.

49. The method of claim 48 further comprising establishing a wireless network around the large infrastructure using the plurality of magnetometers.

50. A means for securing a large infrastructure comprising:
means for establishing a wireless network around the large infrastructure using a plurality of magnetometers;
means for sensing at least a magnetic flux and a change in magnetic flux around the large infrastructure via at least one magnetometer and generating a sensed signal; and
means for analyzing the sensed signal for determining a local disturbance around the large infrastructure,
wherein the change in the magnetic flux occurs due to the presence of metal objects indicating the local disturbance.
